(19) United States
(12) Patent Application Publication
(10) Pub. No.: US 2012/0049688 A1
(43) Pub. Date: Mar. 1, 2012

(54) Electricity-Generating Device

(76) Inventors: Huan-Ching Tseng, Dalin Township (TW); Chiun-Liang Tsai, Chiayi City (TW); Chun-Hsin Tsai, Chiayi City (TW)

(21) Appl. No.: 12/869,056

(22) Filed: Aug. 26, 2010

(51) Int. Cl. H02K 3/32

(52) U.S. Cl. 310/215

(57) ABSTRACT

An electricity-generating device has a rotator unit comprising a rotator, multiple magnetic strips and a shaft; has an outer stator unit comprising multiple annular steel sheets, multiple dividing boards, multiple insulating sheets, and an outer coil; and has an inner stator comprising multiple annular steel sheets, multiple dividing boards, multiple insulating sheets and inner coil. The shaft is connected to a drive motor and receives power from the drive motor so that the rotator unit rotates between the inner and outer stator units. By continuously shearing to perform electromagnetic inducement interaction, induced current is generated to output and to supply battery charge and outside electrical consumption or to actuate multiple electricity-generating modules arranged in parallel.

### BACKGROUND OF THE INVENTION

1. Field of the Invention

The present invention relates to an electricity-generating device, and more particularly to an electricity-generating device comprising a rotator unit, an outer stator unit and an inner stator unit and connects a drive motor by the rotator unit and receives the power from the drive motor to generate current output by electromagnetic inducement.

2. Description of Related Art

Conventional electricity-generating devices mostly adapt conventional ways of consuming nature resources to transform energy from various resources to electricity. Therefore, consumption of the nature resources is huge and causes many sequential environmental and pollution problems. The drawbacks are:

1. Electricity-generating process consumes huge nature resources, which will be exhausted soon.

2. The pollutant caused during the electricity-generating process pollutes water and air.

3. Building of energy factor causes damage to nature environment, water and soil.

4. Electricity-generating cost is expensive and acquirability of the fuel is difficult and has variations.

5. Other substitutional energy such as solar energy or wind energy that is not stably supplied during the electricity-generating process.

6. Waste caused by the electricity-generating process cannot be treated easily and usually causes environment pollution.

Although conventional electricity-generating device enables to achieve fundamental requirement and efficiency in respect of electricity-generating application, it still has drawbacks and insufficiency about environmental issue, stability, economic and development efficiency, and exclusivity of industrial application so that it cannot develop more specific industrial application.

### SUMMARY OF THE INVENTION

A main objective of the present invention is to provide an electricity-generating device comprising a rotator unit, an outer stator unit and an inner stator unit and connects a drive motor with the rotator unit and receives the power from the drive motor to generate current output by electromagnetic inducement.

To achieve the foregoing objective, the electricity-generating device comprises:

a rotator unit having a rotator, multiple magnetic strips and a shaft, wherein the rotator and the shaft are hollow; the shaft is attached to a closing board on the rotator; and the multiple magnetic strips are mounted around an cylindrical surface of the rotator;

an outer stator unit mounted outside the rotator unit and having multiple first annular steel sheets, multiple first dividing boards, multiple first insulating sheets, and an outer coil; wherein each of the multiple first annular steel sheets has multiple first T-shaped openings; the multiple first annular steel sheets are stacked to make the multiple first T-shaped openings on different multiple first annular steel sheets communicated to perform multiple first T-shaped recesses; each of the multiple first dividing boards has multiple first slits and two side ends having two first ribs respectively to each engage with a corresponding one of the multiple first T-shaped recesses; each of the multiple first insulating sheets is clamped between adjacent two of the multiple first dividing boards and shaped in U-shape with an opening facing to the multiple first annular steel sheet and thus has a first space for accommodating the outer coil;

an inner stator unit mounted inside the rotator unit and having multiple second annular steel sheets, multiple second dividing boards, multiple second insulating sheets, and an inner coil; wherein each of the multiple second annular steel sheets has multiple second T-shaped openings; the multiple second annular steel sheets are stacked to make the multiple second T-shaped openings on different multiple second annular steel sheets communicated to perform multiple second T-shaped recesses; each of the multiple second dividing boards has multiple second slits and two side ends having second ribs respectively to each engage with a corresponding one of the multiple second T-shaped recesses; each of the multiple second insulating sheets is clamped between adjacent two of the multiple second dividing boards and shaped in U-shape with an opening facing to the multiple second annular steel sheet and thus has a second space for accommodating the inner coil; wherein numbers of the multiple first T-shaped recess of the outer stator unit is same as the numbers of the multiple second dividing boards of the inner stator unit to perform one-to-one alignment;

a positioning shaft having a central shaft to penetrate the shaft of the rotator unit;

two caps mounted on two ends of the shaft respectively and each having an end hole, wherein one of the two caps has multiple sets of dual-bearing each having a radius gap; the end hole is penetrated by the central shaft of the positioning shaft; the other of the two end caps has a main bearing penetrated by the shaft of the rotator unit

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an electricity-generating device in accordance with the present invention;

FIG. 2 is a partially exploded perspective view of the electricity-generating device in accordance with the present invention;

FIG. 3 is a perspective view of the electricity-generating device in accordance with the present invention;

FIG. 4 is a cross-sectional view of the assembled electricity-generating device along line A-A in FIG. 3;

FIG. 5 is a cross-sectional view of the assembled electricity-generating device without coils;

FIG. 6 is a cross-sectional view of the stator unit along line B-B in FIG. 5; and

FIG. 7 is a cross-sectional view of the assembled electricity-generating device along line C-C in FIG. 6.

### DETAILED DESCRIPTION OF THE PREFERRED EMBODIMENT

An electricity-generating device in accordance with the present invention has a rotator unit comprising a rotator, multiple magnetic strips and a shaft; has an outer stator unit comprising multiple annular steel sheets, multiple dividing boards, multiple insulating sheets, and an outer coil; and has an inner stator comprising multiple annular steel sheets, multiple dividing boards, multiple insulating sheets and inner coil. The shaft is connected to a drive motor and receives power from the drive motor so that the rotator unit rotates between the inner and outer stator units. By continuously shearing to perform electromagnetic inducement interaction, induced current is generated to output and to supply battery charge and outside electrical consumption or to actuate multiple electricity-generating modules arranged in parallel.

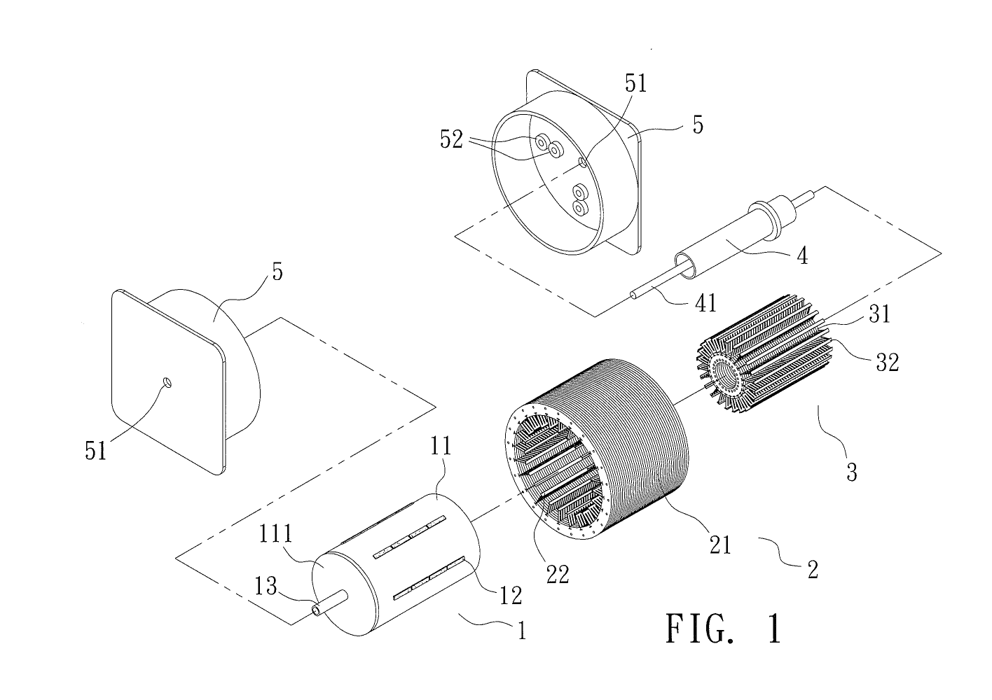

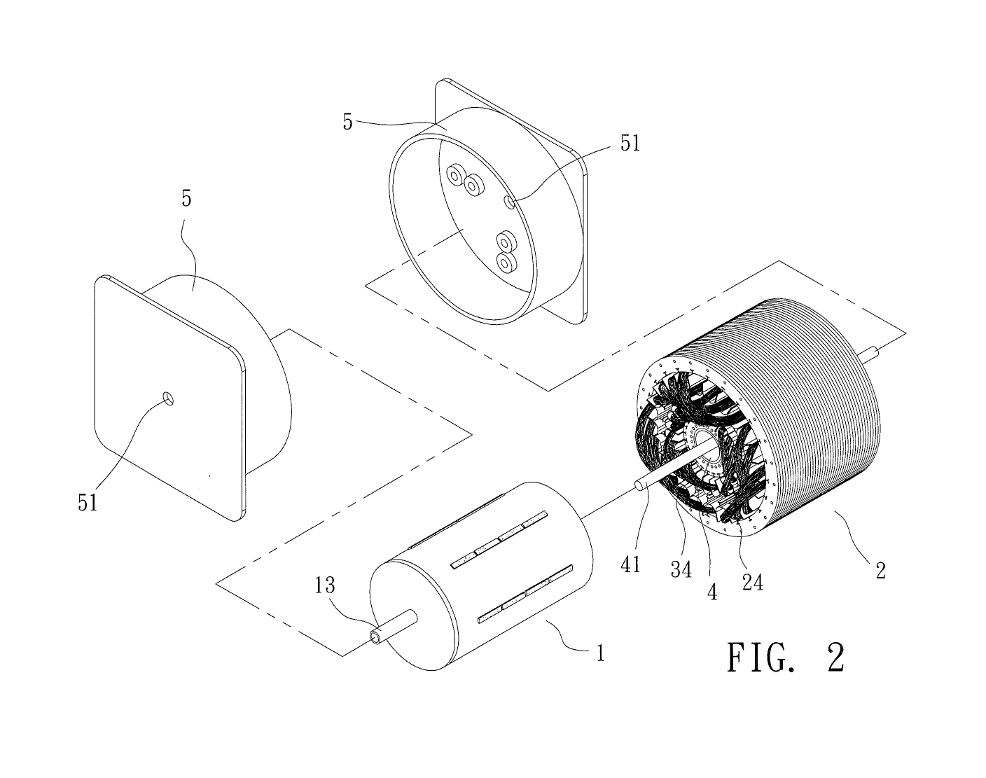

As shown in FIGS. 1 and 2, a preferred embodiment of a mainframe of the electricity-generating device in accordance with the present invention comprises a rotator unit 1, an outer stator unit 2, an inner stator unit 3, a positioning shaft 4 and two end caps 5, wherein:

The rotator unit 1 contains a rotator 11, multiple magnetic strips 12 and a shaft 13. The rotator 11 and the shaft 13 are both hollow and the shaft 13 is attached to a closing board 111. The multiple magnetic strips 12 are arranged on an outer periphery of the rotator 11 alternatively in sectional arrangement or continuous arrangement.

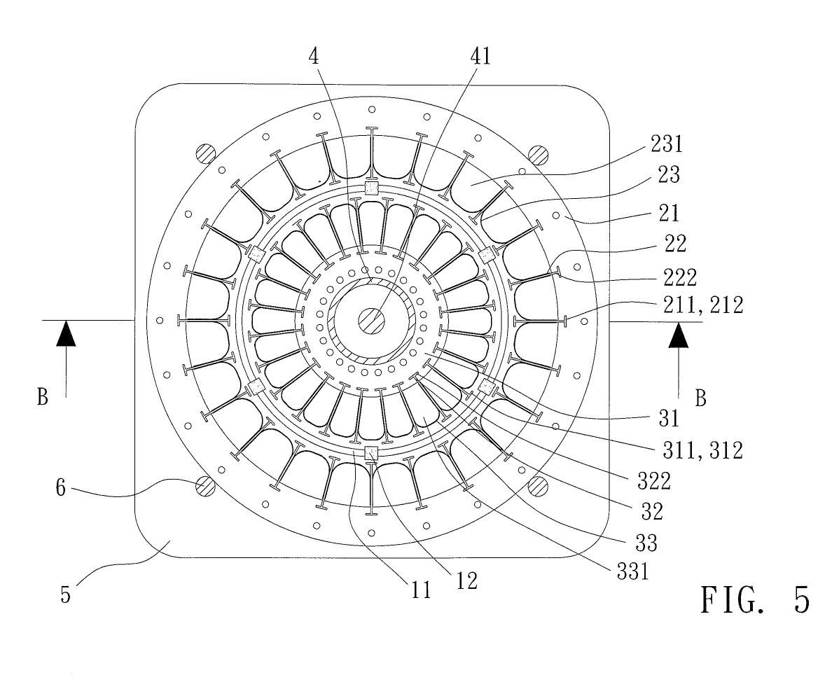

The outer stator unit 2 contains multiple first annular steel sheets 21, multiple first dividing boards 22, multiple first insulating sheets 23 (as shown in FIG. 5), and an outer coil 24.

The inner stator unit 3 is attached inside the outer stator unit 2 and contains multiple second annular steel sheets 31, multiple second dividing boards 32, multiple second insulating sheets 33 (as shown in FIG. 5), and an inner coil 34.

The positioning shaft 4 has a central shaft 41 and penetrates the shaft 13 of the rotator unit 1.

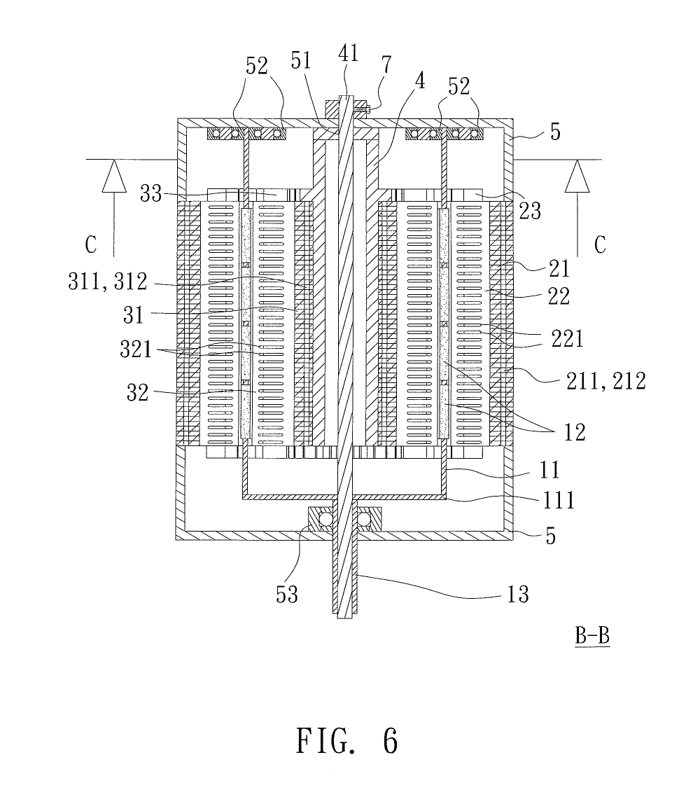

The two end caps 5 each contain an end hole 51. One of the two end caps 5 has multiple sets of dual-bearing 52 evenly arranged in radius. The end hole 51 is penetrated by the central shaft 41 of the positioning shaft 4. The other of the two end caps 5 has a main bearing 53 (as shown in FIG. 6) penetrated by the shaft 13 of the rotator unit 1. Each of the multiple dual-bearings 52 has a radius gap to receive a corresponding distal end of the rotator 11 of the rotator unit 1 after assembly.

The rotator unit 1 is clamped between the outer stator unit 2 and the inner stator unit 3 and rotates freely. The shaft 13 extends its two ends out of the two end caps 5 respectively and is adapted to electrically connect to a drive motor to generate electricity.

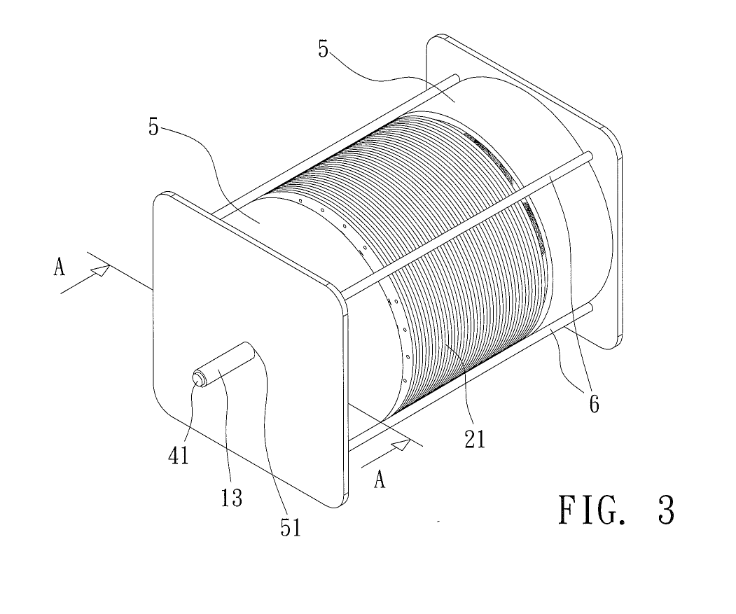

With reference to FIG. 3, the electricity-generating device is assembled, wherein the outer stator unit 2 and the inner stator unit 3 (as shown in FIG. 1) between the end caps 5 at two ends. Multiple bracing rods 6 are extended between the two end caps 5 to fix the position of the combination of the outer stator unit 2 and the inner stator unit 3. After assembling the end caps 5 with the combination of the outer stator unit 2 and the inner stator unit 3, only the first annular steel sheets 21 is exposed in appearance and other components are covered inside. The central shaft 41 of the positioning shaft 4 (as shown in FIG. 1) penetrates the hollow shaft 13 of the rotator unit 1 and extends outside from end holes 51 of the end caps 5.

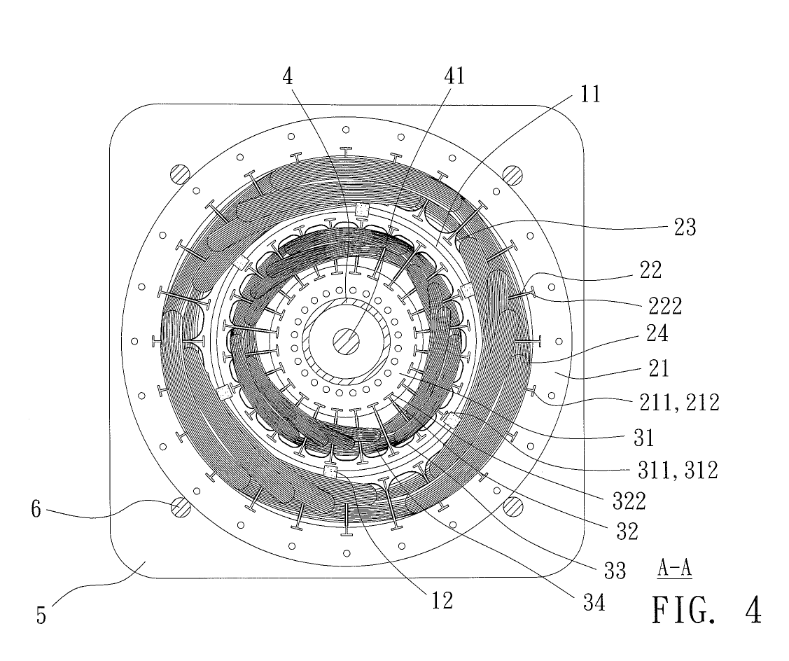

As shown in FIGS. 4 to 6, a preferred embodiment of the electricity-generating device in the present invention comprises:

The rotator unit 1 contains the rotator 11, the multiple magnetic strips 12 and the shaft 13. The rotator 11 and the shaft 13 are both hollow and the shaft 13 is attached to the closing board 111. The multiple magnetic strips 12 are arranged on the outer periphery of the rotator 11 alternatively in sectional arrangement or continuous arrangement (embodiments shown by the drawings). The sectional arrangement of the multiple magnetic strips 12 sufficiently reduces the temperature of the rotator 11 and increases the magnetic flux density.

The outer stator unit 2 contains the multiple first annular steel sheets 21, the multiple first dividing boards 22, the multiple first insulating sheets 23, and the outer coil 24. The multiple first annular steel sheets 21 each have multiple first T-shaped openings 211 defined on inner edge thereof. The multiple first annular steel sheets 21 are stacked up into a cylinder and the multiple first T-shaped openings 211 on one first annular steel sheet 21 are aligned with other first T-shaped openings 211 on the other first annular steel sheets 21 to perform multiple T-shaped recesses 212 in the cylinder. Each of the multiple first dividing boards 22 has multiple first slits 221. Two ends of each first dividing board 22 respectively have a first rib 222. The first ribs 222 on the two ends of the first dividing board 22 respectively engage the corresponding first T-shaped recess 212 of the multiple first annular steel sheets 21. Numbers of the multiple first T-shaped recesses 212 are corresponding (same) to the numbers of the multiple first dividing boards 22. The multiple first insulating sheets 23 are located each between adjacent two of the multiple first dividing boards 22 and each shaped in U-shape with an opening facing the multiple first annular steel sheets 21 and having a first space 231 to accommodate the outer coil 24 penetrating the first space 231. The above-mentioned outer coil 24 of the outer stator unit 2 penetrates one first space 231 of one first insulating sheet 23, crosses over adjacent several first insulating sheets 23 (adjacent four first insulating sheets 23 in this embodiment) and then penetrates the next first insulating sheet 23 after the adjacent several first insulating sheets 23 repeatedly. This arrangement not only reduces the winding times (few winding times of the coil by crossing over several first insulating sheets 23) but also reduces the numbers of the magnetic (i.e. the magnetic strips 12).

The inner stator unit 3 is attached inside the outer stator unit 2 and contains the multiple second annular steel sheets 31, the multiple second dividing boards 32, the multiple second insulating sheets 33, and the inner coil 34. The multiple second annular steel sheets 31 each have multiple second T-shaped openings 311 defined on inner edge thereof. The multiple second annular steel sheets 31 are stacked up into a cylinder and the multiple second T-shaped openings 311 on one second annular steel sheet 31 are aligned with other second T-shaped openings 311 on the other second annular steel sheets 31 to perform multiple T-shaped recesses 312 in the cylinder. Each of the multiple second dividing boards 32 has multiple second slits 321. Two ends of each second dividing board 32 respectively have a second rib 322. The second ribs 322 on the two ends of the second dividing board 32 respectively engage the corresponding second T-shaped recess 312 of the multiple second annular steel sheets 31. Numbers of the multiple second T-shaped recesses 312 are corresponding (same) to the numbers of the multiple second dividing boards 32. The multiple second insulating sheets 33 are located each between adjacent two of the multiple second dividing boards 32 and each shaped in U-shape with an opening facing the multiple second annular steel sheets 31 and having a second space 331 to accommodate the inner coil 34 penetrating the second space 331. The above-mentioned inner coil 34 of the inner stator unit 3 penetrates one second space 331 of one second insulating sheet 33, crosses over adjacent several second insulating sheets 33 (adjacent four second insulating sheets 33 in this embodiment) and then penetrates the next second insulating sheet 33 after the adjacent several second insulating sheets 33 repeatedly. This arrangement not only reduces the winding times (few winding times of the coil by crossing over several second insulating sheets 33) but also reduces the numbers of the magnetic (i.e. the magnetic strips 12).

The multiple first dividing boards 22 of the outer stator unit 2 and the multiple second dividing boards 32 of the inner stator unit 3 are preferably arranged interlaced in radius to reduce the starting torque force.

The positioning shaft 4 has the central shaft 41 and penetrates the shaft 13 of the rotator unit 1. The central shaft 41 of the positioning shaft 4 is fixed by a screw 7 so that the shaft 13 of the rotator unit 1 rotates in relative to the central shaft 41 but the central shaft 41 does not rotate.

The two end caps 5 each contain the end hole 51. One of the two end caps 5 has the multiple sets of dual-bearing 52 evenly arranged in radius. The end hole 51 is penetrated by the central shaft 41 of the positioning shaft 4. The other of the two end caps 5 has the main bearing 53 penetrated by the shaft 13 of the rotator unit 1. Each of the multiple dual-bearings 52 has a radius gap to receive a corresponding distal end of the rotator 11 of the rotator unit 1 after assembly.

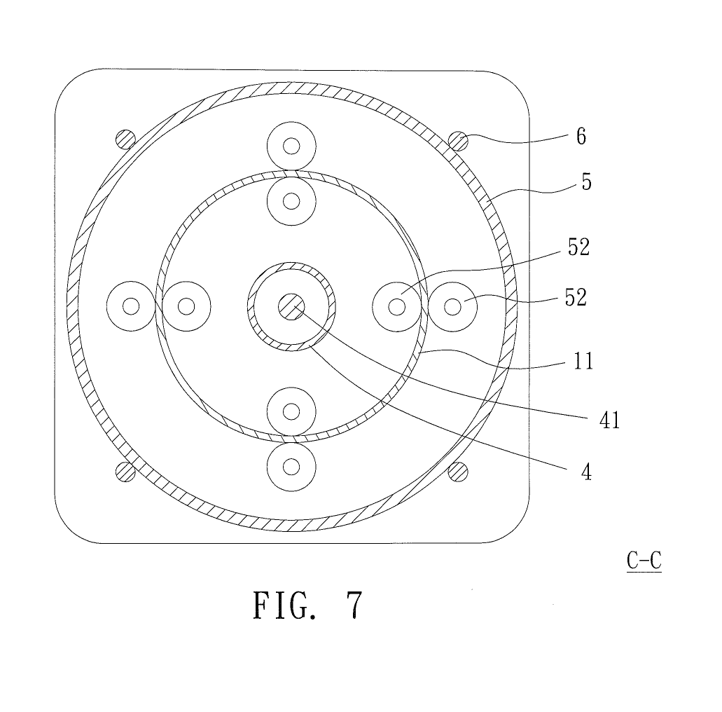

As shown in FIG. 7, wherein the multiple dual-bearings 52 of the end cap 5 limits the rotation deviation of the rotator 11. The center of the end cap 5 is the central shaft 41 of the positioning shaft 4 which is immovable.

When operates, the electricity-generating device in the present invention is connected to a drive motor (not shown) by the shaft 13 (as shown in FIG. 1) and receives the power from the drive motor to make the rotator unit 1 rotate between the outer stator unit 2 and the inner stator unit 3 (as shown in FIG. 4). By continuously shearing the magnetic lines to perform magnetic inducement and generate induced current output, the current supplies charge of battery (small quantity electricity) and outer electricity consumption (large quantity electricity) such as industrial electricity consumption, commercial electricity consumption and household electricity consumption.

A battery connected to the driven motor must have sufficient initial electricity to actuate the electricity-generating device to start the electricity-generating process. Once the electricity-generating device starts generating electricity, it continues to charge the battery and then the electricity of the battery drives the drive motor to perform electricity-generating process with cyclic efficiency. The electricity output of the electricity-generating device will be continued without interruption theatrically and only to be stopped until one of the battery, the drive motor or the electricity-generating device needs to be repaired or replaced.

The electricity-generating device as described above not only enable to supply general outer electricity consumption (industrial electricity, commercial electricity, and household electricity) but also operationally connects with multiple electricity-generating modules in parallel unlimited in augmentation to collect large electricity output.

According to above description, the advantages of the present invention are listed below.

1. Without using nature resources (hydraulic power, fire power or nuclear power etc.) to generate electricity, electricity-generating cost is significantly reduced and environment-friendly to reduce carbon-emission.

2. By attaching more than one electricity-generating modules respectively providing different quantity of electricity for different application consumption, the combination of the electricity-generating device can be arranged into different sizes for different spaces.

3. Users enable to adjust the scale of the electricity-generating device to meet different electricity requirement in different places so that the electricity-generating device has variety in arrangement for all-aspect and flexible applications.

4. The electricity-generating device only needs small quantity electricity to actuate, has high energy efficiency and can be downsized in scales and size of relative elements to significantly reduce electricity-generating cost.

5. The slits defined on the dividing boards of the stator units sufficiently reduce power consumption caused by wind pressure or magnetic retard when the rotator rotates so that electricity-generating efficiency in improved.

6. By having the winding structure alternative with interval and interlacing (better than the conventional repeating winding means), the inner coil and the outer coil has more sufficient coil numbers and increased density to improve effective magnetic inducement when the magnetic field changes.

7. By winding the inner coil and the outer coil with adjacent four insulating sheets spaced, this arrangement not only reduce the numbers of the magnetic (magnetic strips) but also have the optimum balance between the torque output (generated electricity) and the winding times of the coil and the magnetic quantity.

8. The multiple first dividing boards of the outer stator unit and the multiple second dividing boards of the inner stator unit are preferably arranged interlaced in radius. Such arrangement reduces the starting torque force.

9. The outer coil of the outer stator unit provides the electricity to the electricity-generating device for its own consumption and the inner coil of the inner stator unit provides electricity to outside electricity supplement so that this electricity-generating device has larger electricity output than the one of conventional electricity-generating device having singular stator unit.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. An electricity-generating device comprising:
a rotator unit having a rotator, multiple magnetic strips and a shaft, wherein the rotator and the shaft are hollow; the shaft is attached to a closing board on the rotator; and the multiple magnetic strips are mounted around an cylindrical surface of the rotator;
an outer stator unit mounted outside the rotator unit and having multiple first annular steel sheets, multiple first dividing boards, multiple first insulating sheets, and an outer coil; wherein each of the multiple first annular steel sheets has multiple first T-shaped openings; the multiple first annular steel sheets are stacked to make the multiple first T-shaped openings on different multiple first annular steel sheets communicated to perform multiple first T-shaped recesses; each of the multiple first dividing boards has multiple first slits and two side ends having two first ribs respectively to each engage with a corresponding one of the multiple first T-shaped recesses; each of the multiple first insulating sheets is clamped between adjacent two of the multiple first dividing boards and shaped in U-shape with an opening facing to the multiple first annular steel sheet and thus has a first space for accommodating the outer coil;
an inner stator unit mounted inside the rotator unit and having multiple second annular steel sheets, multiple second dividing boards, multiple second insulating sheets, and an inner coil; wherein each of the multiple second annular steel sheets has multiple second T-shaped openings; the multiple second annular steel sheets are stacked to make the multiple second T-shaped openings on different multiple second annular steel sheets communicated to perform multiple second T-shaped recesses; each of the multiple second dividing boards has multiple second slits and two side ends having second ribs respectively to each engage with a corresponding one of the multiple second T-shaped recesses; each of the multiple second insulating sheets is clamped between adjacent two of the multiple second dividing boards and shaped in U-shape with an opening facing to the multiple second annular steel sheet and thus has a second space for accommodating the inner coil; wherein numbers of the multiple first T-shaped recess of the outer stator unit is same as the numbers of the multiple second dividing boards of the inner stator unit to perform one-to-one alignment;
a positioning shaft having a central shaft to penetrate the shaft of the rotator unit;
two caps mounted on two ends of the shaft respectively and each having an end hole, wherein one of the two caps has multiple sets of dual-bearing each having a radius gap; the end hole is penetrated by the central shaft of the positioning shaft; the other of the two end caps has a main bearing penetrated by the shaft of the rotator unit.

2. The electricity-generating device as claimed in claim 1, wherein the multiple magnetic strips are arranged in sectional arrangement or continuous arrangement.

3. The electricity-generating device as claimed in claim 1, wherein numbers of the multiple second T-shaped recesses is same as numbers of the second dividing boards in the inner stator unit.

4. The electricity-generating device as claimed in claim 1, wherein the multiple first dividing boards of the outer stator unit and the multiple second dividing boards of the inner stator unit are arranged interlaced to each other in radius.

5. The electricity-generating device as claimed in claim 1, wherein the outer coil of the outer stator unit penetrates one first space of one first insulating sheet, crosses over adjacent several first insulating sheets and then penetrates the next first insulating sheet after the adjacent several first insulating sheets repeatedly.

6. The electricity-generating device as claimed in claim 5, wherein the adjacent several first insulating sheets are adjacent four first insulating sheets.

7. The electricity-generating device as claimed in claim 1, wherein the inner coil of the inner stator unit penetrates one second space of one second insulating sheet, crosses over adjacent several second insulating sheets and then penetrates the next second insulating sheet after the adjacent several second insulating sheets repeatedly.

8. The electricity-generating device as claimed in claim 7, wherein the adjacent several second insulating sheets are adjacent four second insulating sheets.

9. The electricity-generating device as claimed in claim 1, wherein the radius gaps of the multiple dual-bearings receive a distal end of the rotator of the rotator unit.

10. The electricity-generating device as claimed in claim 1, wherein the central shaft of the positioning shaft is fixed by a screw so that the shaft of the rotator unit rotates in relative to the central shaft.
